(19) United States
(12) Patent Application Publication
(10) Pub. No.: US 2005/0017536 A1
(43) Pub. Date: Jan. 27, 2005

(54) Dumpster cover assembly

(76) Inventor: Bruce Carl Dapprich, Pittsburgh, PA (US)

Correspondence Address: Bruce Carl Dapprich, 171 Gass Road, Pittsburgh, PA, 15229, US

(21) Appl. No.: 10/626,070

(22) Filed: Jul. 24, 2003

(51) Int. Cl. B60P 7/02

(52) U.S. Cl. 296/100.1

(57) ABSTRACT

The ‘Dumpster Cover Assembly’ is an attachable ‘hook-on’ tarp and bow cargo cover; to enclose the open tops of roll off dumpsters used for refuse disposal typically in construction, demolition, renovation, or environmental remediation projects. The ‘Dumpster Cover Assembly’ is the only universal tarp and bow system that can be installed without welding, drilling or modifying the roll off dumpster in any way. Bows are suspended across the dumpster body and attached to brackets that ‘hook-on’ invertedly to the outer top dumpster rails and hang on the inside of the dumpster body; and a tarp or canvas cover is suspended over top of the bows and partially down the sides of the dumpster where it is secured with cord, bungy straps, or lockable steel cable. The cover assembly is portable, interchangable, quickly installed, detachable, and can be used as a temporary or permanent enclosure. The roll off dumpster can be transported and unloaded with the cover assembly in place as the tarp cover complies with DOT regulations.

### CROSS-REFERENCE TO RELATED APPLICATIONS

Dumpster Cover Assembly—Provisional Patent Application USPTO# 60/363347-Mar. 11, 2002

### DESCRIPTION OF THE INVENTION

1. Background of the Invention

The invention relates to a common problem with open top roll off dumpsters wherein the open top allows access to the contents of the dumpster from the outside as well as the problem of the contents of the dumpster not being enclosed and exposed to the outside environment. The open top of a common roll off dumpster allows exposure of the contents to the environment and permits weather conditions, children, animals, or people access to the contents of the dumpster and/or allows unwanted material or debris to be thrown into the dumpster by unsecured personnel. The ‘Dumpster Cover Assembly’ permits the contents of the roll off dumpster to be enclosed and secured eliminating exposure of the contents to the outside environment while keeping the dumpster easily accessable for loading needs from the top or through the rear door. It is light weight and transportable when installed.

2. Brief Summary of the Invention

The ‘Dumpster Cover Assembly’ is a light weight, portable, removable, interchangable, ‘hook-on’ bow assembly with nylon, canvas, or vinyl cover that restricts the exposure of the contents of the dumpster to the outside environment while limiting access to the contents inside the dumpster. The dumpster cover ‘hooks-on’ to the outer top rail of the dumpster and can be installed without tools to any common roll off dumpster without making modifications to the dumpster itself. The ‘Dumpster Cover Assembly’ is able to be dismantled and transported via car or pickup truck to any job site location for installation. The ‘Dumpster Cover Assembly’ allows the dumpster to be loaded from the top or rear door and can quickly be secured at the end of the days work. Additionally, the sloped cover design keeps rain, water, or snow from accumulating inside the dumpster. Dumpster liners can be installed first with the assembly brackets fitting over top of the poly liners without tape or glue securing the liner up and over the dumpster top rail. Upon completion of loading the dumpster, the cover assembly can be removed or the dumpster can be transported for unloading with the cover assembly in place. Thickness of the nylon, canvas, or vinyl cover will determine the compliance with D.O.T. regulations.

### BRIEF DESCRIPTION OF THE SEVERAL VIEWS OF THE DRAWING

FIG. 1—Side view of the bracket hooks comprised of approx. 1/4 inch hardened steel bar shaped to specifications.

FIG. 2—Wood block or metal flange that comprises the bracket body.

FIG. 3—Size and depth of drill holes into wood or metal block bracket body.

FIG. 4—Side view of the steel hooks attached to the wood or metal block bracket body. There are two hooks per wook block. This completes the assembly of a single bracket.

FIG. 5—Assembled brackets are hooked onto the upper rails of the dumpster. There are two brackets per bow one hooked to either side of the dumpster.

FIG. 6—Bows are shaped to approximate specifications with 3/4 inch aluminum tubing.

FIG. 7—Assembled brackets are hung and positioned along both sides of the dumpster top rail parallel to one another.

FIG. 8—Bows are inserted through 1 inch holes on the bracket assembly suspending them across the top of the dumpster.

FIG. 9—Rear view of hung brackets and inserted bows across top of dumpster.

FIG. 10—A nylon, canvas, or vinyl cover is draped over top of the dumpster bows and over all four sides of the dumpster and pulled tight and secured through grommet holes along the edges of the cover to the outer dumpster body with cord, bungy straps, or lockable steel cable.

### DETAILED DESCRIPTION OF THE INVENTION

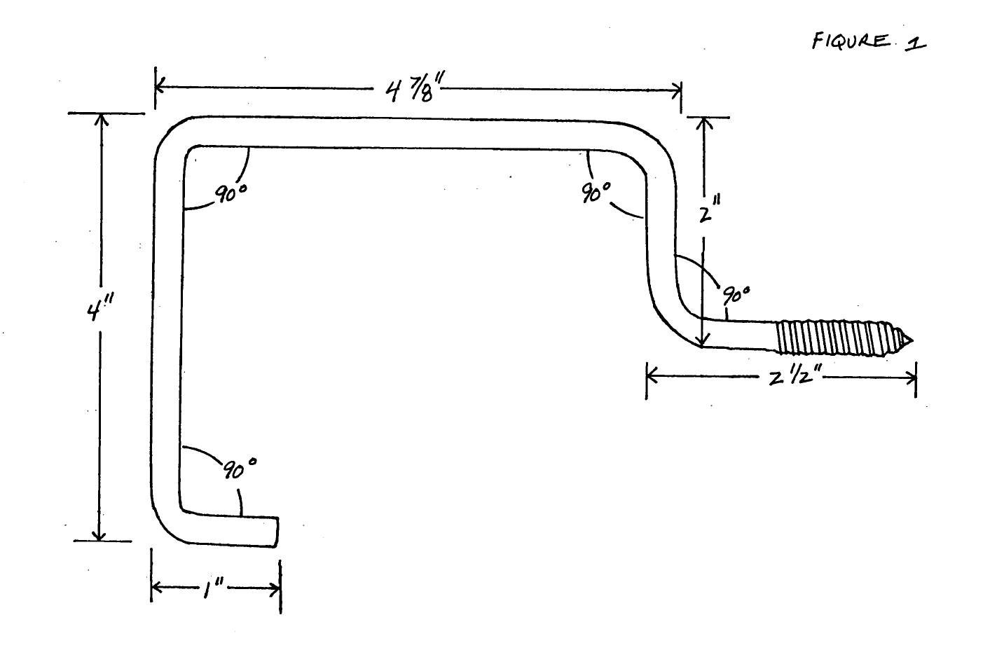

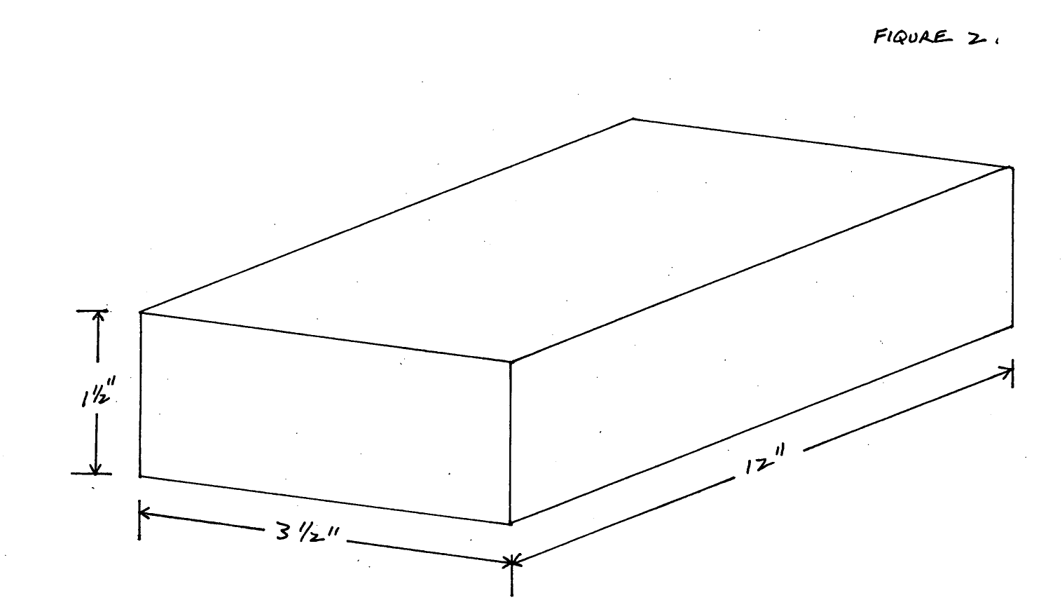

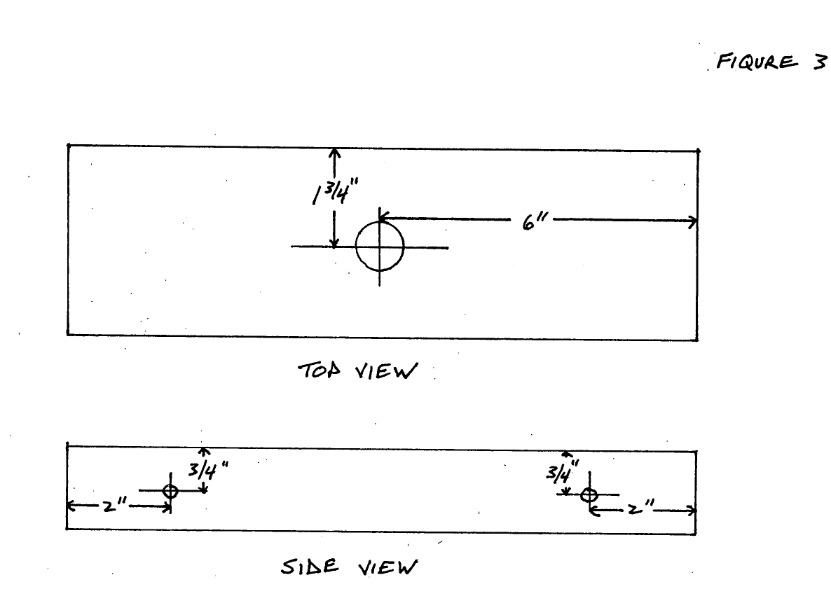

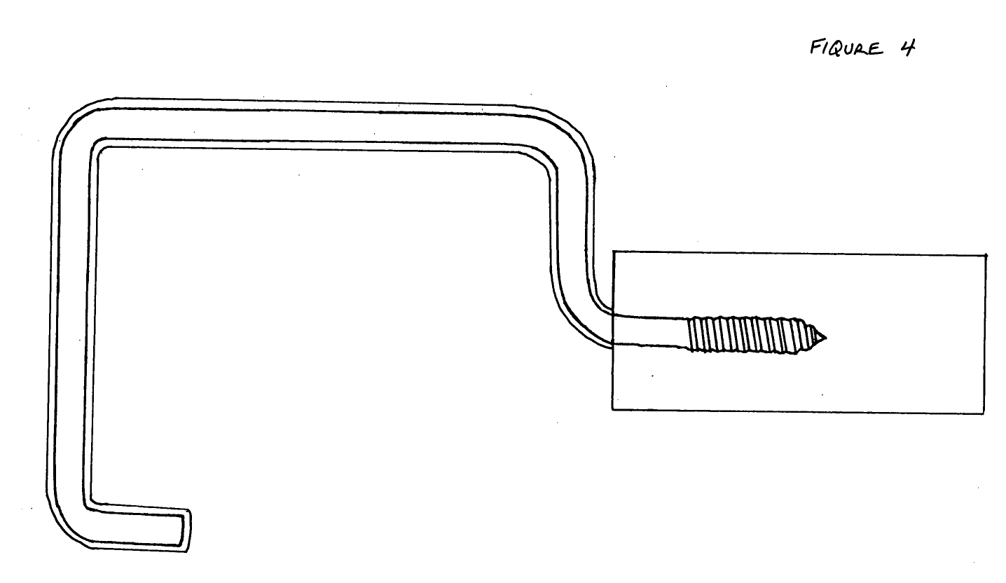

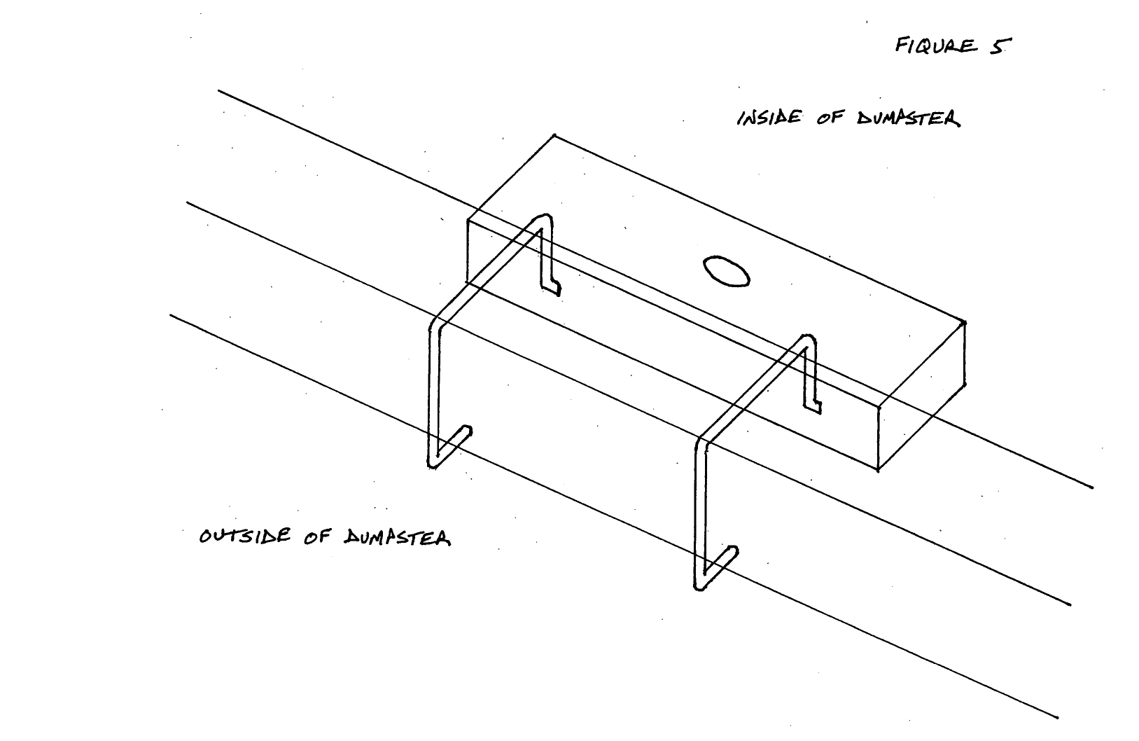

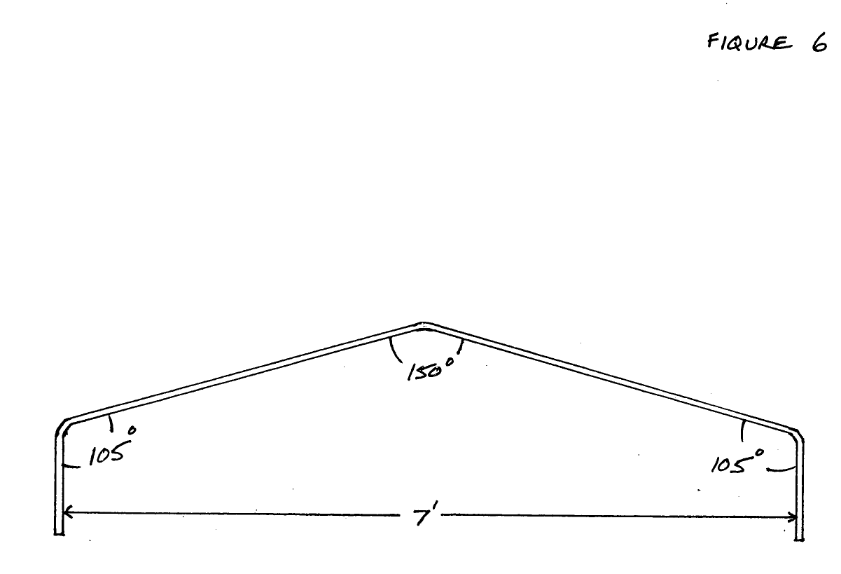

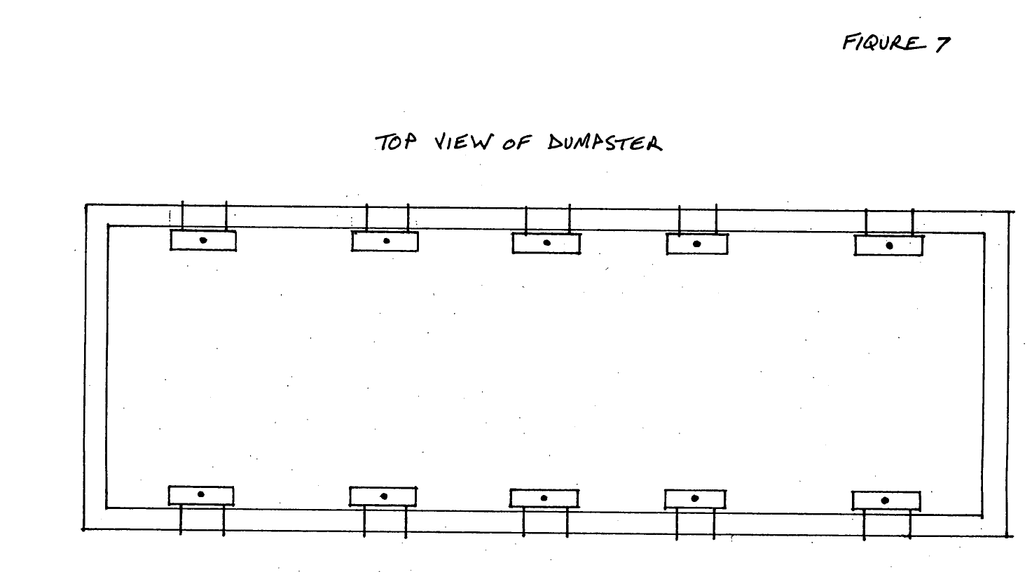

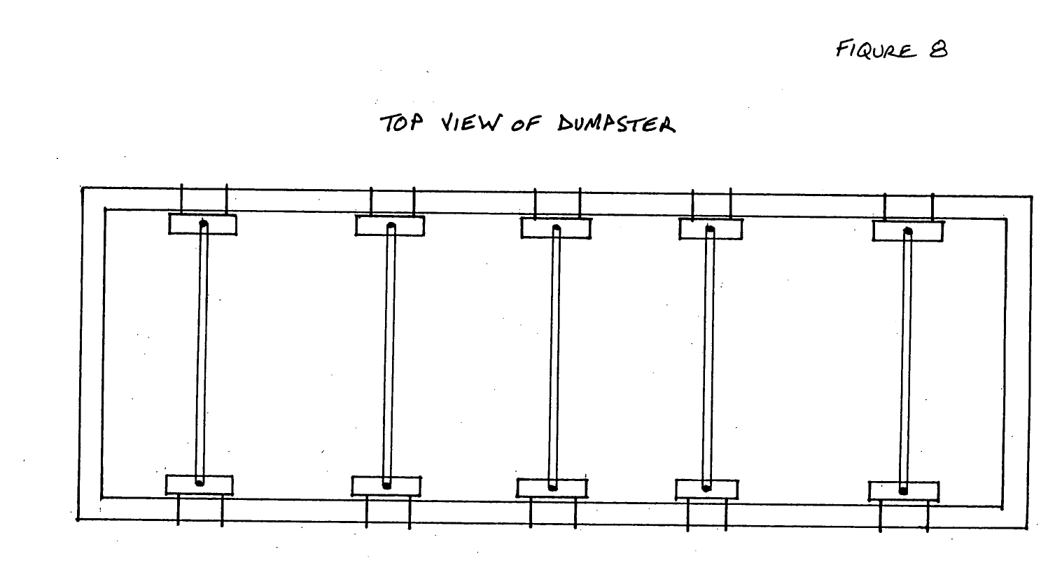

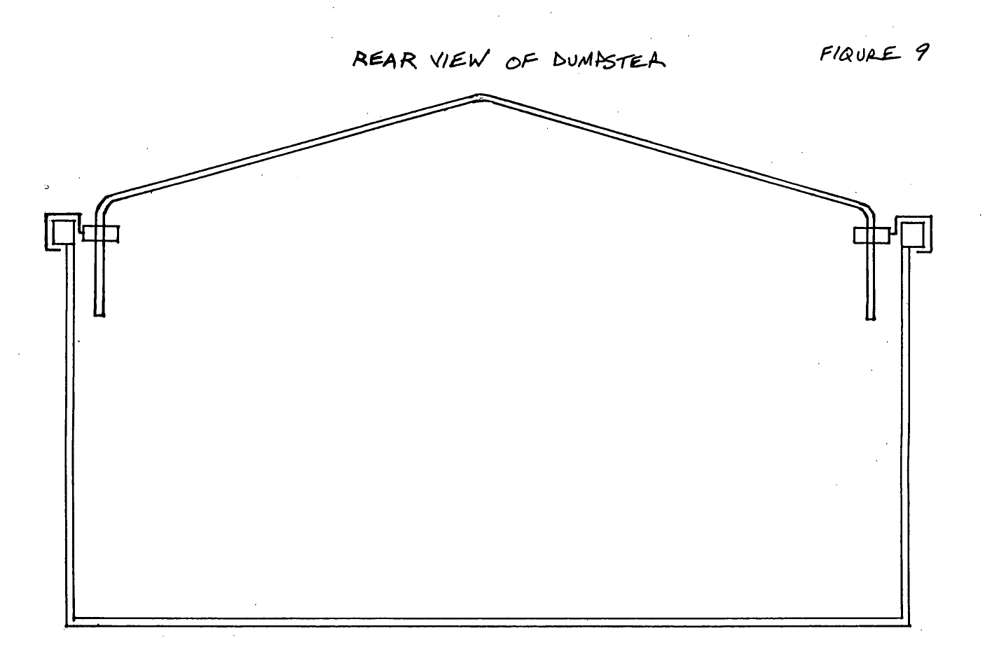

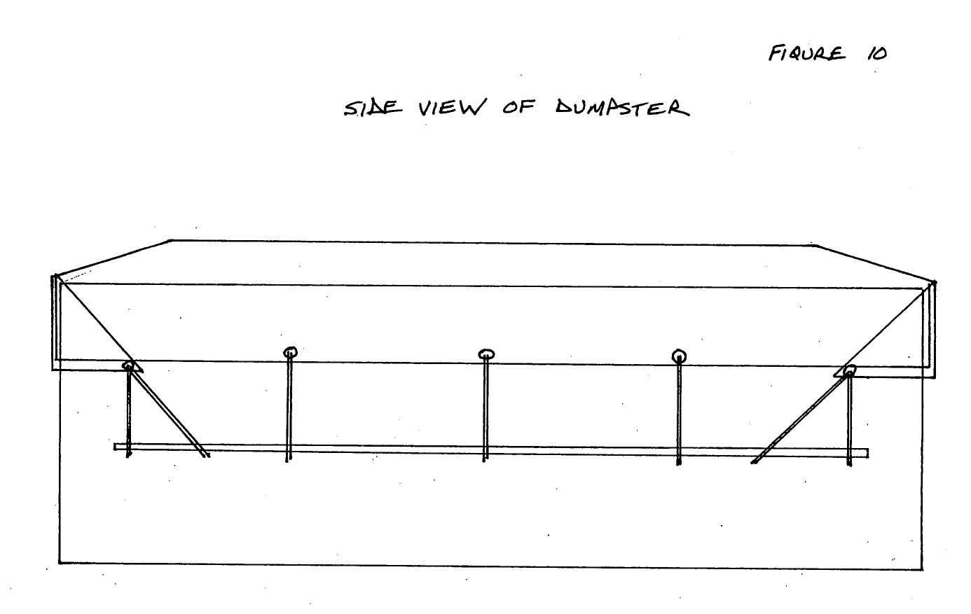

The dumpster cover assembly is a tarp and bow cargo cover system that ‘hooks-on’ to the top rail of any roll off construction dumpster and is suspended across the top of the dumpster enclosing it's contents. The system is held in place by manufactured brackets consisting of inverted hooks shaped to fit around and over the top dumpster rails (FIG. 1, FIG. 2). Two hooks are attached to a wood or metal bracket body to create one single bracket (FIG. 3, FIG. 4). Bow brackets are attached to the dumpster and held in place by the inverted hooks onto the top rails of the dumpster with the bracket hanging towards the inside of the dumpster body (FIG. 5). Bows are manufactured from metal tubing and shaped with a pitch to allow for water runoff (FIG. 6). Brackets are hung and aligned along both sides or the dumpster body to allow for bows to be inserted. There are two brackets per bow (FIG. 7). The bows are attached to the brackets by inserting the bow ends through holes in two attached brackets that are ‘hooked-on’ to the top rails of the dumpster suspending the bow across the top of the dumpster body (FIG. 8, FIG. 9). After assembling several suspended bows across dumpster body, a nylon, canvas, or vinyl cover is draped over top of the bows and partially down all four sides of the dumpster and secured through grommet holes to the sides of the dumpster with cord, bungy straps, or lockable steel cable (FIG. 10).

1. What I claim as my invention is a roll off construction dumpster cover assembly that ‘hooks-on’ to the top rail of a roll off dumpster enclosing the open top of the dumpster without welding, drilling, or altering the dumpster in any way.

2. What I claim my invention is a roll off construction dumpster cover assembly that can be universally attached to any construction dumpster.

3. What I claim my invention is a roll off construction dumpster cover assembly that is a tarp and bow system that limits access to the contents of the dumpster and encloses the dumpster contents eliminating exposure to the outside environment, people, and weather conditions.
